(19) United States
(12) Patent Application Publication
(10) Pub. No.: US 2013/0124661 A1
(43) Pub. Date: May 16, 2013

(54) SYSTEMS AND METHODS FOR PROVIDING SIMPLIFIED COMPUTING FUNCTIONALITIES TO A USER

(71) Applicant: Andrew Dowling, Willoughby (AU)

(72) Inventor: Andrew Dowling, Willoughby (AU)

(73) Assignee: TAPESTRY PTY LTD, Willoughby, NSW (AU)

(21) Appl. No.: 13/810,730

(22) PCT Filed: Jul. 19, 2011
(86) PCT No.: PCT/AU2011/000910

§ 371 Date: Jan. 17, 2013

(30) Foreign Application Priority Data
Jul. 19, 2010 (AU) 2010903220

(51) Int. Cl. H04L 12/58

(52) U.S. Cl. CPC H04L 51/10
USPC 709/206; 709/217

(57) ABSTRACT

Described herein are systems and methods for providing simplified computing functionalities to a user. In overview, an arrangement is provided whereby a simplified computing device is provided to a user, for example a user with relatively low computer literacy. The device provides a user interface, which is preferably remotely configurable by another user via a remote terminal. This in some embodiments is achieved by a web-based intermediary service, which may be a subscription-based service. In some embodiments the user interface is remotely configured to provide the user with simplified access to multimedia, messaging, and some data obtained from social networking facilities. In some embodiments various forms of web content shared by various channels are normalized for display on the simplified computing device.

### FIELD OF THE INVENTION

The present invention relates to systems and methods for providing simplified computing functionalities to a user, and in some embodiments to a simplified computing platform. Embodiments of the invention have been particularly developed for providing simplified computing functionalities to less computer literate segments of the community, including older generations. Whilst some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Advances in technology, for example in the context of computing platforms and social networking, provide difficulties to less computer literate segments of the community. Members of such segments are often deprived of the ability to keep in touch with others via such technologies, or otherwise derive the benefits of such technologies. This is particularity relevant given the wide range of content shared via the Internet, and the numerous channels used to share that content.

### SUMMARY OF THE INVENTION

It is an object of the present invention to overcome or ameliorate at least one of the disadvantages of the prior art, or to provide a useful alternative.

One embodiment provides a method for providing simplified computing functionalities to a user, the method including:

receiving, via one of a plurality of input channels, data indicative of content for display at a simplified computing platform;

processing the data thereby to identify an account holder to which the content is directed;

processing the data thereby to determine a primary content type;

extracting one or more content items of the primary content type from the data;

defining a signal for communication to a simplified computing platform associated with the identified account holder, thereby to instruct the simplified computing platform to make the one or more content items available for display via a software module configured specifically for the display of content of the primary content type;

providing the signal to the simplified computing platform.

One embodiment provides a device for providing simplified computing functionalities to a user, the device including:

a processor;

a memory module coupled to the processor, the memory module maintaining software instructions for providing a user interface; and

a communications interface coupled to the processor for allowing the device to communicate with a remote terminal;

wherein one or more functionalities of the user interface are configured by operation of the remote terminal.

One embodiment provides a system for providing simplified computing functionalities to a user, the system including:

a web interface for allowing communication with one or more standard computing platforms and one or more simplified computing platforms, thereby to a given one of the standard computing platforms to configure one or more functionalities of a user interface provided by a given one of the simplified computing platforms.

One embodiment provides a method for providing simplified computing functionalities to a user, the method including:

receiving from a client data indicative of a simplified computing platform and configuration instructions in respect of a user interface provided by that simplified computing platform; and

providing instructions to the simplified computing platform thereby to configure user interface provided by that simplified computing platform in accordance with the configuration instructions.

One embodiment provides a method for providing simplified computing functionalities to a user, the method including:

receiving data from a social networking facility;

modifying that data based on a set of user interface configuration data associated with a simplified computing platform;

delivering the modified data to a user of the simplified computing platform.

One embodiment provides a method for providing simplified computing functionalities to a user, the method including:

providing a user interface; and

modifying the operation of the user interface based on configuration instructions provided by a remote device.

One embodiment provides a computer system including a web server configured to deliver a web based interface to a plurality of user terminals, wherein the web server is configured to perform a method as described herein.

One embodiment provides a computer system including a microprocessor configured to perform a method as described herein.

One embodiment provides a tangible non-transient computer readable medium carrying executable code that when executed on one or more microprocessors of a computer system cause the computer system to perform a method as described herein.

One embodiment provides a computer program product configured for allowing the performance of a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 schematically illustrates a communications framework according to one embodiment.

FIG. 2 illustrates a simplified computing platform according to one embodiment.

FIG. 3 provides a system level overview according to one embodiment.

FIG. 4 illustrates an arrangement according to one embodiment.

FIG. 5 illustrates a method according to one embodiment.

### DETAILED DESCRIPTION

Described herein are systems and methods for providing simplified computing functionalities to a user. In overview, an arrangement is provided whereby a simplified computing device is provided to a user, for example a user with relatively low computer literacy. The device provides a user interface, which is remotely configurable by another user via a remote terminal. This in some embodiments is achieved by a web-based intermediary service, which may be a subscription-based service. In some embodiments the user interface is remotely configured to provide the user with simplified access to multimedia, messaging, and data obtained from social networking facilities. In some embodiments various forms of web content shared by various channels are normalized for display on the simplified computing device.

### General Framework

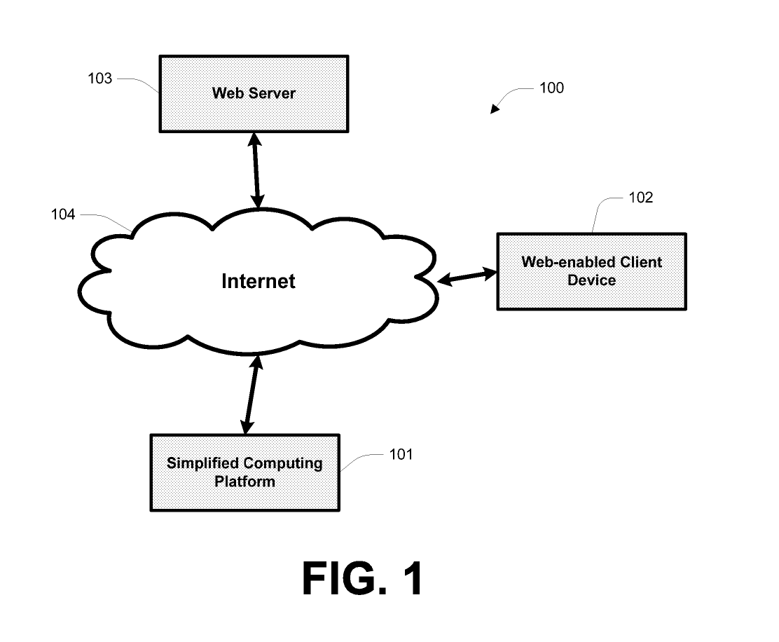

FIG. 1 provides a schematic overview of a general communications framework 100. A simplified computing platform 101, web-enabled client device 102, and web server 103 are all in communication via the Internet 104.

Simplified computing device 101 is preferably a tablet type device, and additional description of its makeup is provided further below. At a general level, device 101 is intended for use by relatively computer illiterate segments of the community, for example older people, mentally handicapped, and persons with relatively little experience using computers. Accordingly, the level of functionality provided is limited thereby to reduce complexity. A basic user interface executes by default on the device, this user interface providing simplified access to multimedia, messaging, and some data obtained from social networking facilities. In some embodiments additional functionality is provided, including functionality related to healthcare provision, and monitoring of wellbeing.

The user interface of device 101 is remotely configurable. That is, advanced aspects of computer configuration, management and the like are able to be conducted remotely. In the present embodiment this is achieved by web-enabled device 102, which may be a standard personal computer. A user of device 102 provides configuration instructions, which are transmitted to configure the user interface of device 101. In some embodiments this includes providing instructions to device 101. In other embodiments the configuration occurs at web server 103. For example, whereas in some cases the logic for driving various user interface functionalities of device 101 is provided locally at the device, in other embodiments the device operates as a thin client with that logic being maintained at web server 103.

At a practical level, one application for device 101 is for consumers to purchase device 101 for their parents. The consumers are able to remotely manage the operation of the device thereby to provide their parents with a simple computing platform that operates in a manner so as to allow the consumers to provide their parents with a desired level of functionality.

In some cases the device 101 is operated subject to a subscription-based service. This subscription preferably includes access to an Internet service provider, combined with access to services provided by server 103. In use, a subscription is preferably obtained prior to initial startup of device 101, which is subsequently commissioned (either pre-purchase or post purchase) to be associated with a resulting set of subscription data. Accordingly, once commissioned, the device is able to be turned on at which time it automatically connects to the Internet.

In some embodiments web server 103 provides users of devices 102 with a range of functionalities with which a particular device 101 may be configured. Examines include simple messaging services, access to news information, access to healthcare functionalities and the like, and simplified access to social networking.

In terms of social networking, one embodiment includes a method of receiving data from a social networking facility (such as Facebook or the like), modifying that data based on a set of user interface configuration data associated with a simplified computing platform, and delivering the modified data to a user of the simplified computing platform. For example, rather than requiring a user of platform 101 access a social networking site in the conventional manner, they are provided with a feed of data controlled by the party responsible for configuring device 101.

In one embodiment web server 103 provides an interface whereby third parties may be authorized to access functionality thereby to deliver specific content (such as messages, photos, and the like) to a specified device 101.

In some embodiments device 101 is configured to provide a “heartbeat” indicative of usage of the device, thereby to provide an indication of use. This is helpful in assessing the wellbeing of the user. For instance, by receiving acknowledgement that the user of device is active, interested parties are able to monitor health at a high level. In some embodiments device 101 is configurable to allow monitoring of specific health issues.

In some embodiments framework 100 provides two fundamental components:
A simplified touch-screen tablet device, and
An integrated social network.

These work in tandem to help seniors stay connected to their families. It does this by integrating a number of disparate capabilities, each of which on its own may not be new, but which are combined in original ways to create and reinforce connections between members of the network, specifically tailored to the needs of senior users. These features include but are not limited to:
The ability to share photos and videos by subscribing family members using any source (phone, camera, computer etc) which appear instantaneously on the photo frame device for viewing, browsing and management
Simplified communication features linked to the photo sharing capability providing bidirectional communication between network members, including both stateless (e.g. email) and real-time (e.g. live voice, live video, chat) mechanisms
Entertainment capabilities including games, e-books & magazines, applications, and other content
Integrated health and welfare monitoring and reporting, and integration with peripheral devices

These capabilities are tied together and linked to the social network to allow family members to both actively and passively care for senior relatives. The use of sharing or entertainment features, for example, is used as input data to the health and mood monitoring features, which provide early warning of problems related to physical and mental health.

The emphasis on connection extends to an innovative payment system, where subscription fees are borne by family members rather than the user of the device, with family members choosing how their contributions are manifested in the features available to the device user. This incorporates an advanced algorithm for optimizing contributions from family members based on usage and behavioral patterns.

The user interface of the device is designed to meet the specific needs of senior users, who may face difficulties with impaired vision, restricted movement and reduced ability to process complex, fast-changing information on-screen, and who are largely unfamiliar with existing computer user interface norms.

### Exemplary Device

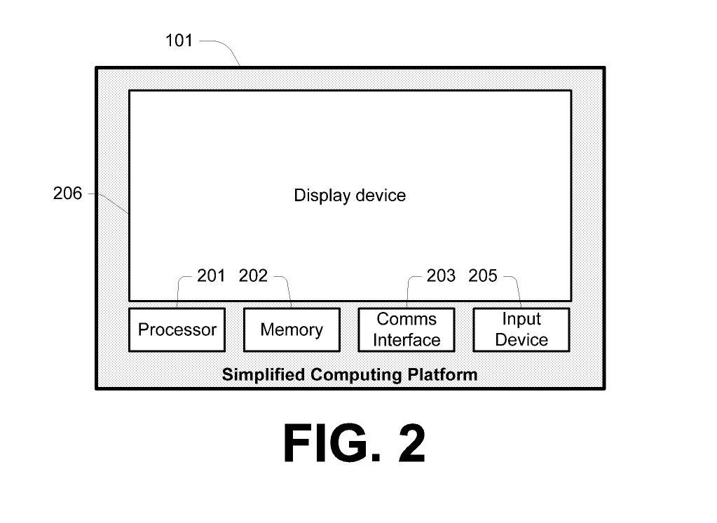

FIG. 2 illustrates a simplified computing platform 101 according to one embodiment. Device 101 includes a processor 201 coupled to a memory module 202 and a communications interface 203 (such as an internet connection, modem, Ethernet port, serial port, or the like), and input device 205 (including the likes of a touch screen and/or one or more buttons). Memory module 202 includes software instructions, which are executable on processor 201. These software instructions allow platform 101 to execute a software application, such as a proprietary application or web browser application and thereby render on-screen a user interface. This user interface allows for the creation, viewing and administration of profiles, access to the internal communications interface, and various other functionalities.

### Normalization of Incoming Data

In some embodiments, framework 100 is configured for normalizing content for display at a simplified computing platform. In overview, a wide range of forms of content (such as messages, media, links, and so on) are commonly shared via the Internet, over a wide range of sharing technologies (such as email, social networking sites such as Facebook and Google+, media sharing sites such as YouTube, Photobucket and Rich). Framework 100 is configured to receive data from a range of sharing technologies, determine the form on content, and deliver it to simplified computing platforms in a normalized manner.

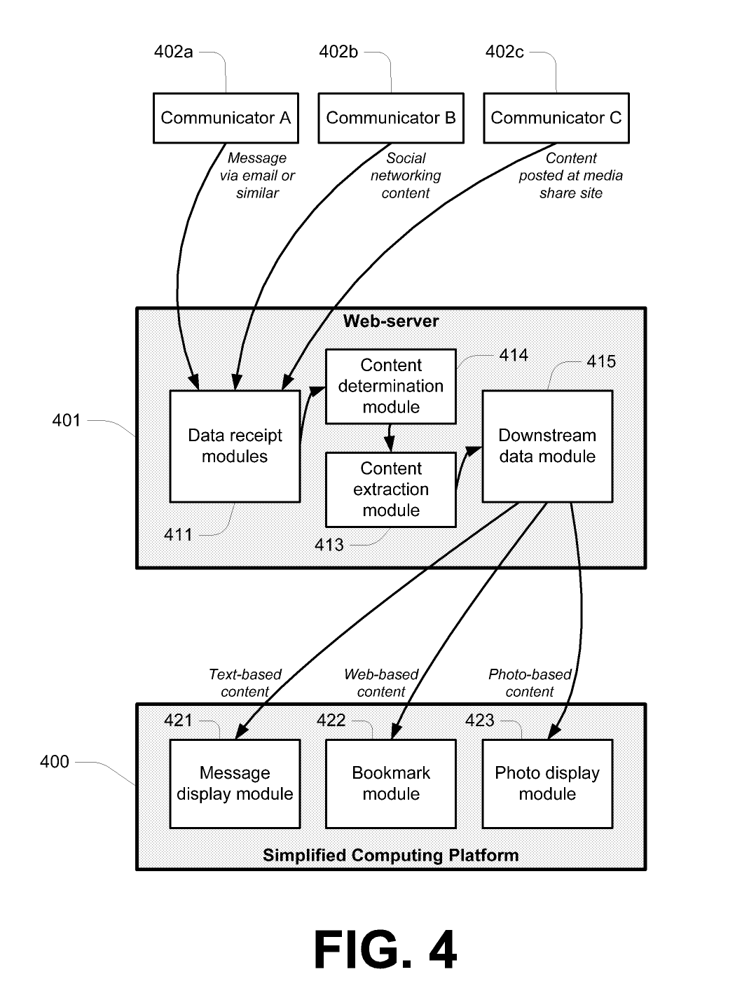

FIG. 4 illustrates an arrangement including a simplified computing platform 400, which communicates over the Internet with a simplified computing service provider web server 401. This web server is configured for normalizing content for provision to a plurality of simplified computing platforms (although only one is shown in FIG. 4).

In this example there are three communicators (402a, 402b and 402c). These communicators provide providing data including content intended for a user of a simplified computing platform, and may be physically defined by a substantially any computing platform (for example web servers, personal computers, portable devices, cellular telephones, and so on) or a user of any such computing platform. The communication channels intermediate the communicators and server 401 are simplified for the sake of convenient illustration, noting that there may be various intermediate devices responsible for passing data signals. It will be appreciated that in practice there may be a large number of communicators, in some cases favoring the use of multiple servers such as server 401 to handle the quantum of traffic.

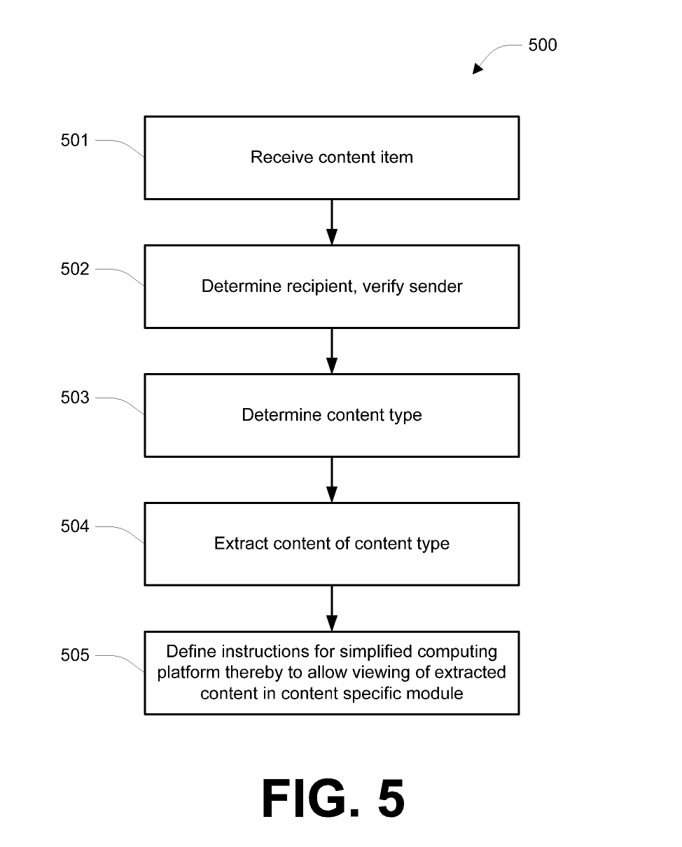

Server 401 is illustrated in terms of functionally defined modules. The operation of these modules is described by reference to method 500 of FIG. 5, which illustrates a method performed by server 401 according to one embodiment. It will be appreciated that in other embodiments method 500 is performed in whole or in part by a component other than server 401.

A plurality of data receipt modules are configured for receiving, via a respective plurality of input channels, data indicative of content for display at a simplified computing platform. In some cases the content is for display at a plurality of simplified computing platforms (for example where the data is addressed to multiple simplified computing platform users, or addressed to a user associated with multiple simplified computing platforms). The input channels may include any of the following:
Email. This may include emails sent to an address defined specifically for the purpose of receiving content for delivery to a simplified computing platform, or alternately a regular (for example pre-existing) email address. In the case of the latter, arrangements are made for mail delivered to/received at the regular email address to be delivered to server 401. One or more of modules 411 is configured to receive data indicative of such emails.
Other forms of messaging. This may include messages transmitted via instant messaging services, via messaging interfaces provided by various web facilities (such as messaging facilities in social network facilities), SMS/MMS messaging, and so on. Once again, where appropriate message forwarding protocols are implemented. One or more of modules 411 is configured to receive data indicative of such messages.
Posts made via a social networking facility. The term “post”, in this context, should be read broadly and describes substantially any form of content shared via a social networking facility. One or more of modules 411 is configured to receive data indicative of such posts. In some embodiments a plugin or the like is used to modify the operation of a social networking facility user's account settings thereby to allow integration with server 401. For example, in some cases an option is provided to automatically share certain categories of posts with specified users of simplified computing platforms. In some cases such an option is provided on a post-by-post basis. Some embodiments use social networking facility notifications, “tagging”, and the like is leveraged to identify data indicative of content that is intended for the user of a simplified computing platform.
Content shared via a content sharing facility. Content sharing facilities (such as Youtube and Flickr) allow users to share content, such as photo albums, videos, and so on. One or more of modules 411 is configured to receive data indicative of such content.

In the context of method 500, data indicative of content is received via a given one of input channels at 501. Each instance is processed at 502 thereby to determine one or more intended recipients, each recipient being a registered user of a simplified computing platform 400. This is used to determine to which platform 400 the content is to be delivered. In some cases a given user is associated with a plurality of simplified computing platforms, in which case it is determined that the relevant content is to be delivered to that plurality of platforms. The precise nature of step 501 depends on the nature of data received. For example, in the case of an email or other message, an intended recipient is inherently identifiable. In some cases the data is inherently indicative of a recipient (for example by embedding a recipient ID in the data), or a indicative of a sender associated with one or more recipients (i.e. the recipient or recipients are identified based on the identity of the sender).

In some cases the sender's identify is verified, thereby to restrict communication with platform 400 to approved senders.

A content determination module is configured for processing received data thereby to determine a primary content type at 503. Once the primary content type is determined, a content extraction module extracts content of the primary content type from the received data. This may include a single content item, or multiple content items. The primary content type is identified from a predefined selection of primary content types, each content type having an associated software module installed at simplified computing platform 400 configured specifically for the display of content of that primary content type. In some cases not all platforms 400 have the same software modules installed; accordingly in some embodiments server 401 maintain access to data indicative of applications installed on the platform or platforms to which a particular instance of data is directed thereby to influence the determination of a primary content type. Preferably, however, there is a limited set of possible primary content types (preferably between 3 and 8), each being associated with a respective software application installed at each platform 400. For example, any of the following may apply:
The primary content type is images, and the associated software module is an image display module 423.
The primary content type is text, in which case the associated software module is a message display module 421.
The primary content type is a web address, in which case the associated software module may be a web browser application having bookmark storage functionality 422. Preferably, however, web addresses are handled based on the form of content they access. For example, a web address that links to an image is preferably handled as an image rather than a bookmark.

It will be appreciated that the primary content type may be other forms of media, in which case the associated software module is a software application configured to display the relevant form of other media. In some cases the primary content type may include an application that is installable and executable on platform 400.

Various examples of content extraction approaches are outlined below. It will be appreciated that these are not intended to be necessarily limiting or exclusive.
In some cases, where the received data is indicative of a web address that links to an image or a page containing one or more images, the primary content type is determined to be “images” and the image or images are made available for display in the image display module. That is, although the data is in essence a web address, rather than treating that as a bookmark for a web browser, the web addresses is processed based on a set of rules thereby to determine whether the link represents another content type (such as images). In some such cases extracting the image or images includes downloading the image or images from the web address, and the method further includes transmitting the image or images to the simplified computing platform. In other cases the image display module is configured to transparently access links to images rather, negating the need for image download (noting that download may be challenging for some content sharing facilities). In some cases, web addresses are assessed, and a determination is made to treat them as bookmarks intended to be accesses by the user of a platform 400.
In some cases the data is an email, and the primary content type is determined to be an image (for example an image attached to the email). The one or more images are extracted from the email and made available for display via a software module configured specifically for the display of images. That is, rather than treating such an email as an email per se, and making it available in a messaging application, primary content is extracted and treaded appropriately thereby to simplify computing for the end user (e.g. emailed photos automatically appear in the user's photo album).
In some cases, the data is an email, and the primary content type is determined to be a text-based message, such that one or more images are extracted from the email and made available for display via a non-email text-based message software module. In this manner, the user is presented with a non-email text-based message software module, which is able to be significantly simpler than a conventional email interface.
In some cases the data is indicative of a post made via a social networking facility, and the method includes extracting the one or more content items from the social networking facility. For example the one or more content items extracted from the social networking facility are determined to have a primary content type of image, such that one or more images are extracted from the social networking facility and made available for display via a software module configured specifically for the display of images. In other cases text-based posts are extracted and delivered for display via the messaging module.

A downstream messaging module 414 is configured for defining and delivering a signal to the relevant a simplified computing platform (or platforms) associated with the identified account holder, thereby instruct the simplified computing platform for make the one or more content items available for display via a software module configured specifically for the display of content of the primary content type. This occurs at step 505 of FIG. 5.

Normalization as discussed above is particularly useful in the context of providing simplified computing functionalities. In particular, a user of a simplified computing platform is able to experience content from a wide range of sources whilst only using a small number of content-specific software modules.

### Exemplary System-Level Overview

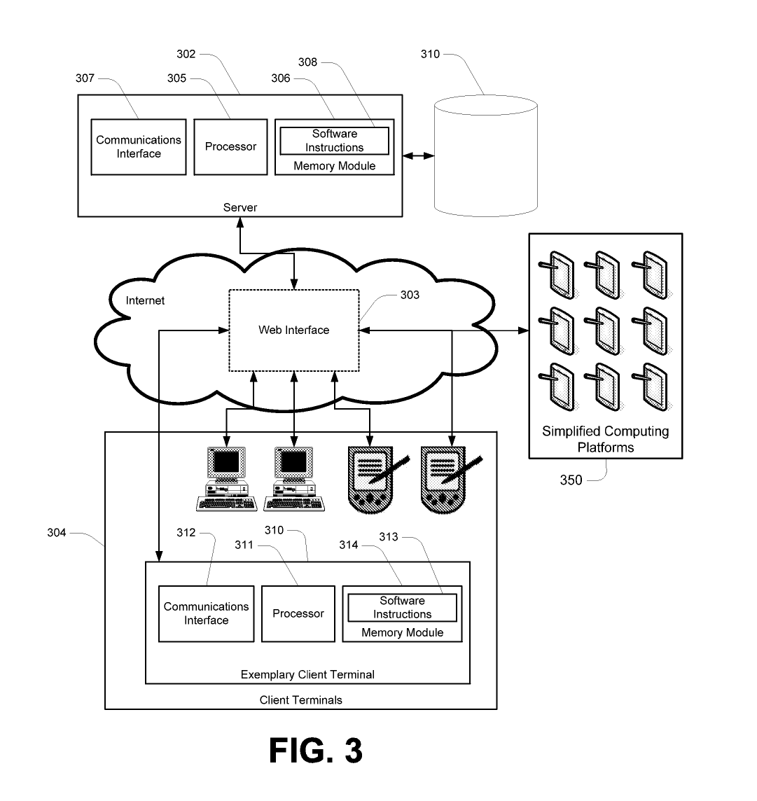

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices. A group 350 of devices 101 also communicate with web server 302.

Server 302 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310 (which may provide the functionality of any one or more of databases 103, 105 and 106), which in some embodiments includes a plurality of distributed storage locations. In further embodiments the database leverages memory module 306. Database 310 maintains a data indicative of employer profiles and jobseeker profiles (including data for allowing the viewing of both public and private profiles).

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD), LED, display or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### CONCLUSIONS

It will be appreciated that the disclosure above provides various novel and inventive systems and methods for providing a simplified computing functionalities, for example by normalization of content shared over the Internet. It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A method for providing simplified computing functionalities to a user, the method including:
receiving, via one of a plurality of input channels, data indicative of content for display at a simplified computing platform;
processing the data thereby to identify an account holder to which the content is directed;
processing the data thereby to determine a primary content type;
extracting one or more content items of the primary content type from the data;
defining a signal for communication to a simplified computing platform associated with the identified account holder, thereby to instruct the simplified computing platform to make the one or more content items available for display via a software module configured specifically for the display of content of the primary content type;
providing the signal to the simplified computing platform.

2. A method according to claim 1 wherein the plurality of input channels includes at least two of: email, posts made via a social networking facility, and content shared via a content sharing facility.

3. A method according to claim 1 wherein the primary content type is identified from a predefined selection of primary content types, each content type having an associated software module installed at the simplified computing platform configured specifically for the display of content of that primary content type.

4. A method according to claim 1 wherein the primary content types include any two or more of the following:
(i) images, in which case the associated software module is an image display module;
(ii) text, in which case the associated software module is a message display module;
(iii) web address, in which case the associated software module is a web browser application having bookmark storage functionality; and
(iv) other media, in which case the associated software module is a software application configured to display the relevant form of other media.

5. A method according to claim 4 wherein, in the case that the data is indicative of a web address that links to an image or a page containing one or more images, the primary content type is determined to be an image, and the image or images are made available for display in the image display module.

6. A method according to claim 5 wherein extracting the image includes downloading the image or images from the web address, and the method further includes transmitting the image or images to the simplified computing platform.

7. A method according to claim 1 wherein the data is an email, and the primary content type is determined to be an image, such that one or more images are extracted from the email and made available for display via a software module configured specifically for the display of images.

8. A method according to claim 1 wherein the data is an email, and the primary content type is determined to be a text-based message, such that one or more images are extracted from the email and made available for display via a non-email text-based message software module.

9. A method according to claim 1 wherein the data is indicative of a post made via a social networking facility, and the method includes extracting the one or more content items from the social networking facility.

10. A method according to claim 9 wherein the one or more content items extracted from the social networking facility are determined to have a primary content type of image, such that one or more images are extracted from the social networking facility and made available for display via a software module configured specifically for the display of images.

11. A method according to claim 1 wherein the data is an email, and the primary content type is determined to be a bookmark, such that one or more images are extracted from the email and made available for display via a software module configured for web browsing.

12. A device configured to receive the signal generated according to a method of claim 1, the device including computer executable code for providing the simplified computing platform and the software modules configured specifically for the display of the primary content type.

13. A computer system including a web server configured to deliver a web based interface to a plurality of user terminals, wherein the web server is configured to perform a method according to claim 1.

14. A computer system including a microprocessor configured to perform a method according to claim 1.

15. A tangible non-transient computer readable medium carrying executable code that when executed on one or more microprocessors of a computer system cause the computer system to perform a method according to claim 1.

16. A computer program product configured for allowing the performance of a method according to claim 1.

17. (canceled)
